(19) United States
(12) Patent Application Publication
(10) Pub. No.: US 2011/0274118 A1
(43) Pub. Date: Nov. 10, 2011

(54) METHOD AND APPARATUS FOR READING DATA FROM A PROTOCOL STACK OF TRANSMISSION CONTROL PROTOCOL/INTERNET PROTOCOL

(75) Inventor: Fan Liu, Guangdong (CN)

(73) Assignee: SHENZHEN COSHIP ELECTRONICS CO., LTD, Shenzhen, Guangdong (CN)

(21) Appl. No.: 13/142,406

(22) PCT Filed: Dec. 24, 2009
(86) PCT No.: PCT/CN2009/075877

§ 371 Date: Jun. 27, 2011

(30) Foreign Application Priority Data
Dec. 29, 2008 (CN) 200810189145.5

(51) Int. Cl. H04L 12/56

(52) U.S. Cl. 370/419

(57) ABSTRACT

A method and device for accessing data through a stack of Transmission Control Protocol and Internetwork Protocols (TCP/IP). The method includes: obtaining an identifier that designates a plurality of UDP data packets in the User Datagram Protocol (UDP) of the TCP/IP stack; obtaining a total length of UDP data packets to be accessed; obtaining data in the protocol stack according the total length of foregoing designated UDP data packets; copying the designated UDP data packets to a user state. The method uses the identifier to access a plurality of UDP data packets and use the length to determine the number of accessible UDP data packets whereby it can access a plurality of UDP data packet each time. Moreover, it reduces the frequency of system calls when accessing an equal number of UDP data packets and shortens the time of system calls. Therefore, it improves the network I/O capacity.

### CROSS-REFERENCE TO RELATED PATENT APPLICATIONS

This application claims the priority to China Patent Application No. 200810189145.5 filed on Dec. 29, 2008, entitled “Method and Device for Accessing Data in the Protocol Stack of the Transmission Control Protocol/Internet Protocol”, by Fan Liu, the disclosure for which is hereby incorporated herein in its entirety by reference.

### FIELD OF THE INVENTION

The present invention generally relates to a telecommunication technology, and more particular to a method and device for accessing data through a stack of transmission control and internetwork protocols.

### BACKGROUND OF THE INVENTION

It is sometimes necessary to access User Datagram Protocol (UDP) data packets through a stack of Transmission Control Protocol and Internetwork Protocols (TCP/IP) during network programming.

Under the current technology, the method to access data packets is as follows:

Firstly, the data receiver and sender determine the package payload format and the port to receive the UDP data packets; the receiver uses the bind ( ) function to designate the port to receive the UDP data packets and invokes recv ( ) reel/from ( ) or recvmsg ( ) function to monitor the port. Then, the sender sends the data packets to the receiver and the receiver makes system calls to copy an UDP data packet from the TCP/IP protocol stack to the user state. Afterwards, the receiver analyzes the UDP data packet payload according to the determined payload format, and the receiver may process and edit (delete or replace) the UDP data packet, and send the result of the processing to the original sender or other devices.

During the invention, the inventor discovered that each system call may take a period of time. Moreover, it will transform the data from the Kernel state to user state, which will spend a long time computing in the central processing unit (CPU) and slow the network input/output (I/O).

Therefore, a heretofore unaddressed need exists in the art to address the aforementioned deficiencies and in adequacies.

### SUMMARY OF THE INVENTION

In one aspect, the present invention provided a method and device for accessing data through a TCP/IP stack to improve the network I/O capacity.

In one aspect, the present invention provides a method to access data through the TCP/IP stack. The method comprises:

obtaining an identifier, wherein the identifier designates a plurality of UDP data packets accessed from a protocol stack of TCP/IP;

obtaining a length, wherein the length designates a total length of UDP data packets to be accessed;

accessing a number of UDP data packets from the protocol stack according to the total length of the designated UDP data packets; and

copying the corresponding number of UDP data packets to an user state.

Preferably, the total length of UDP data packets designated by the identifier ranges between 5 and 7 UDP data packets.

Preferably, accessing an UDP data packet in the protocol stack when the identifier obtaining unit fails to obtain the identifier.

Preferably, the identifier obtained is the one reserved for UDP.

Preferably, before obtaining the identifier, the method further comprises:

receiving UDP data packets from the UDP socket through a system call.

Preferably, accessing a corresponding number of UDP data packets from the protocol stack according to the total length of the designated UDP data packets comprise:

accessing a corresponding number of UDP data packets wherein a length of the corresponding number of UDP data packet is the same as the total length of the designated UDP data packets; or

accessing a corresponding integer number of UDP data packets wherein the length of the corresponding number of UDP data packets is the closest to and not less than the length of the designated UDP data packets.

In another aspect, a data accessing device is provided. The device comprises:

an identifier obtaining unit adapted to obtain an identifier, wherein the identifier designates a plurality of UDP data packets accessed from the protocol stack of a TCP/IP;

a length obtaining unit adapted to obtain a length, wherein the length designates a total length of UDP data packets to be accessed;

an accessing unit adapted to access a corresponding number of UDP data packets from the protocol stack according to the total length of the designated UDP data packets; and

a copying unit adapted to copy the number of UDP data packets to an user state.

Preferably, the data accessing device further comprises:

the accessing unit is also adapted to access an UDP data packet when the identifier obtaining unit fails to obtain the identifier.

Preferably, the data accessing device further comprises:

the receiving unit is adapted to receive UDP data packets from a UDP socket through a system call.

Preferably, the accessing unit is adapted to access a number of UDP data packets wherein the length of the corresponding number of UDP data packets accessed by the accessing unit is the same as the total length of the designated UDP data packets; or

to access a integer number of UDP data packets wherein the length of the corresponding number of UDP data packets accessed by the accessing unit is the closest to and not less than the total length of designated UDP data packets.

The benefit of the present invention, among other things, is that it uses the identifier to access a plurality of UDP data packets and uses the length to determine the number of accessible UDP data packets whereby it can access a plurality of UDP data packets each time. Moreover, it reduces the frequency of system calls when accessing an equal number of UDP data packets and shortens the time of system calls. Therefore, it improves the network I/O capacity.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a flowchart of the method according to the first embodiment of the present invention;

FIG. 2 is a flowchart of the method according to the second embodiment of the present invention;

FIG. 3 shows the application system structure of the method according to the second embodiment of the present invention;

FIG. 4 shows the structure of the device according to the third embodiment of the present invention; and

FIG. 5 shows the structure of another device according to the third embodiment of the present invention.

### DETAILED DESCRIPTION OF THE INVENTION

In one aspect, a method and device for accessing data through the TCP/IP stack is provided herein to improve the network I/O capacity.

### Embodiment 1

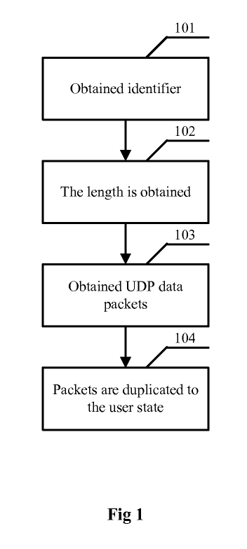

As shown in FIG. 1, one embodiment of the present invention provides a method to access data through the TCP/IP stack, comprising:

Step 101: obtaining an identifier, wherein the identifier designates a plurality of UDP data packets to be accessed from protocol stack of TCP/IP;

Step 102: obtaining a length, wherein the length designates a total length of UDP data packets to be accessed;

Step 103: accessing a corresponding number of UDP data packets from the designated protocol stack according to the total length of the designated UDP data packets; and

Step 104: copying the corresponding number of UDP data packets to an user state.

The method uses the identifier to designate a plurality of UDP data packets to be accessed and uses the length to determine the number of accessible UDP data packets whereby it can access a plurality of UDP data packet each time. Moreover, it reduces the frequency of system calls when accessing an equal number of UDP data packets and shortens the time of system calls. Therefore, it improves the network I/O capacity.

Further, a plurality of UDP data packets can be accessed from each system call. This saves the CPU from transforming UDP data packets from the Kernel state to the user state after each system call, thus decrease the CPU computing time and improves the network I/O capacity.

Further, with shortened computing time, lightened CPU burden and lowered CPU power consumption and CPU temperature, a small heat sink and fan can be mounted. This can help downsize a wide range of digital TV front-end devices of standard sizes in the equipment room under the 1 U structure.

After step 104, the memory space occupied by the UDP data packet in the kernel state can be released.

Preferably, the total length ranges from 5 to 7 UDP data packets' length. This will be further explained in the following embodiments.

Preferably, the identifier can be the UDP reserved identifier.

The method above provides a detailed UDP identifier and the foregoing UDP reserved identifier can be the MSG_WAITALL identifier. Other identifiers or a custom one can also be used to perform the embodiment of the invention.

Preferably, before obtaining the identifier, the method further comprises:

receiving UDP data packets from an UDP socket through a system call and putting the foregoing UDP data packet into the TCP/IP protocol stack.

Preferably, the foregoing UDP data packets accessed according to the total length of the designated UDP data packets may comprise:

UDP data packets accessed according to the total length of the above designated UDP data packets and whose length is the same as the total length; or

UDP data packets accessed according to the total length of designated UDP data packets and whose length is closest to and not less than the total length.

The foregoing embodiment provides two corresponding relationships between the total length of designated UDP data packets and that of the accessed UDP data packets. It is understandable that other types of relationships can also be used to perform the embodiment of the present invention.

### Embodiment 2

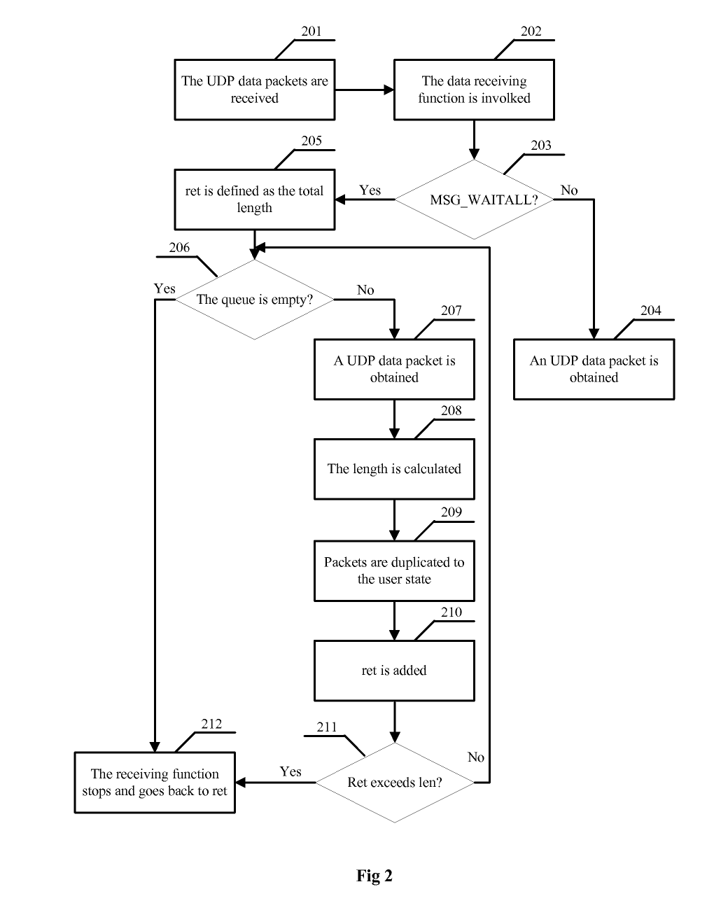

This embodiment will further elaborate on the method provided in the above-mentioned embodiment. This embodiment employs the kernel of Linux-2.6.15 as the application environment. It is understandable that the embodiment of the present invention can be performed in other environments. The implementation of the embodiment is not limited to the above kernel of Linux-2.6.15. As shown in FIG. 2, the method comprises:

Step 201: the application program uses system call functions to receive UDP data packets from the UDP socket.

The system call functions comprises recv ( ) recvfrom ( ) or recvmsg ( );

when receiving UDP data packets, recv, recvfrom or recvmsg are used to receive an UDP data packet from the socket of the UDP port. The input parameter is different, such as:

ssize_t recv (int socket, void *buffer, size_t length, int flags);

ssize_t reel/from (int socket, void *restrict buffer, size_t length, int flags, struct sockaddr *restrict address, socklen_t *restrict address_len); (The last two parameters are NULL by default)

ssize_t recvmsg (int socket, struct msghdr *message, int flags); (The length is hidden in the message); and

Other functions can be used to receive UDP data packets and perform the embodiment of the present invention.

Step 202: System call functions will intervene the system. Re-call the data receiving function in the kernel.

Users can use udp_recvmsg ( ) or other receiving functions to perform the embodiment of the present invention;

Step 203: The data receiving function judges whether the parameter flag is MSG_WAITALL; if yes, go to Step 205; if not, go to Step 204; MSG_WAITALL decides whether a plurality of UDP data packets can be accessed each time;

Step 204: Accessing an UDP data packet and copy it to the user state;

Step 205: Defining ret as the total length of receivable UDP data packets in udp_recvmsg, 0 by default;

Step 206: Judging whether the data queue corresponding to the UDP socket is empty; if yes, go to Step 212; if not, go to Step 207;

Step 207: Obtaining an UDP data packet from the data queue;

Step 208: Calculating the length of the UDP data packet;

Step 209: Copying the UDP data packet from the memory space of the kernel sate into that of the user state and releasing the memory space occupied by the UDP data packet in the kernel state;

Step 210: Adding the UDP data packet's length to ret;

Step 211: Judging whether ret has exceeded the parameter len. If yes, go to Step 212; if not, go to Step 206 and continuing receiving the UDP package; and

Step 212: Quitting the udp_recvmsg function and returning to ret. Showing the length of UDP packages received in the udp_recvmsg function.

Returning to ret can trigger varied results, three of which are described as follows. We assume that the total length of UDP data packets accessible is 1,316 bytes (len is equal to 1,316).

Assuming that the UDP package length is 564, we can call the udp_recvmsg function once to access three UDP data packets of 564 bytes for each, which total 1,692 (564+564+564) bytes. We can also access two UDP data packets only;

If the UDP data packet length is 188, we can call udp_recvmsg once to access seven UDP data packets of 188 bytes for each, which total 1,316 (188×7) bytes; and

If the UDP data packet length is 564 and there are only two UDP data packets in the socket queue (this is possible at the last frame of a program), we can call udp_recvmsg once to access two UDP data packets of 564 bytes for each, which total 1,128 (564+564) bytes;

To test the foregoing embodiments, we select the 825 MHZ CPU MPC8541, 333 MHZ DDR and assume that the length of each receivable UDP package is 1,316 (188×7) and only the code stream is received under the inflow speed of 600 Mbps. The result is as follows:

When the unmodified Linux 2.6.15 kernel and the system call recvfrom is adapted, the CPU utilization rate approached about 70%; and

when the modified Linux 2.6.15 kernel and recvfrom were adapted and five UDP packages were accessed each time, the CPU utilization rate reached about 55%; when seven packages were accessed each time, the CPU utilization rate reached about 50%; when we further increased the number of UDP data packets, package losses occurred.

Therefore, the method provided in the embodiment of the present invention can lower the CPU utilization by 20%, thus improving the CPU's network processing capacity by 40%. The code stream inflow speed is 600/577.5=1.0389 Mbps when using the 1 MHZ CPU and the traditional method or 600/412.5=1.454 Mbps when using the method provided herein).

The total length of UDP data packets designated to be accessed can be the total length of a plurality of UDP data packets. When adopting the method, users can seek to balance the CPU utilization and the number of UDP data packets accessed each time, thus balancing the CPU burden and the transmission speed.

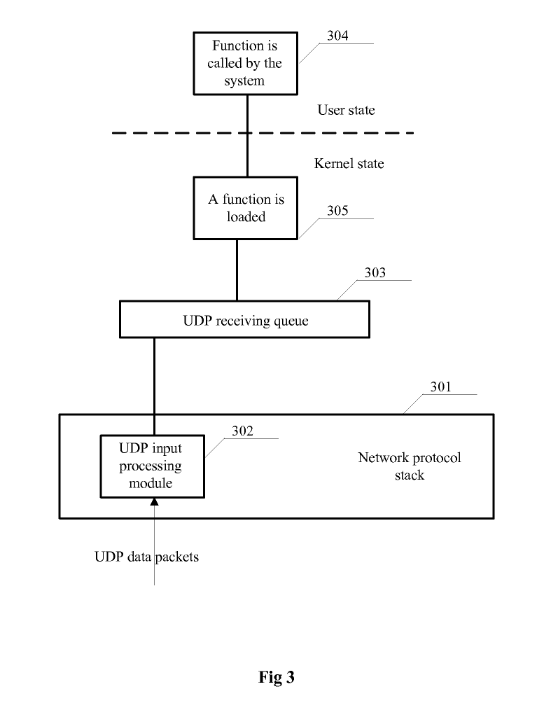

FIG. 3 shows the system structure of an application environment for the embodiment of the present invention. The system structure comprises the local network protocol stack 301 that receives UDP data packets; the UDP input processing module 302 that adds UDP data packets into the UDP receiving queue 304; the user state's system call function 305 and the accessing function 306 that uses the kernel state. The accessing function 306 accesses UDP data packets from the UDP receiving queue 304 according to the designated total length and then returns the data packets to the user state's system call function 305.

### Embodiment 3

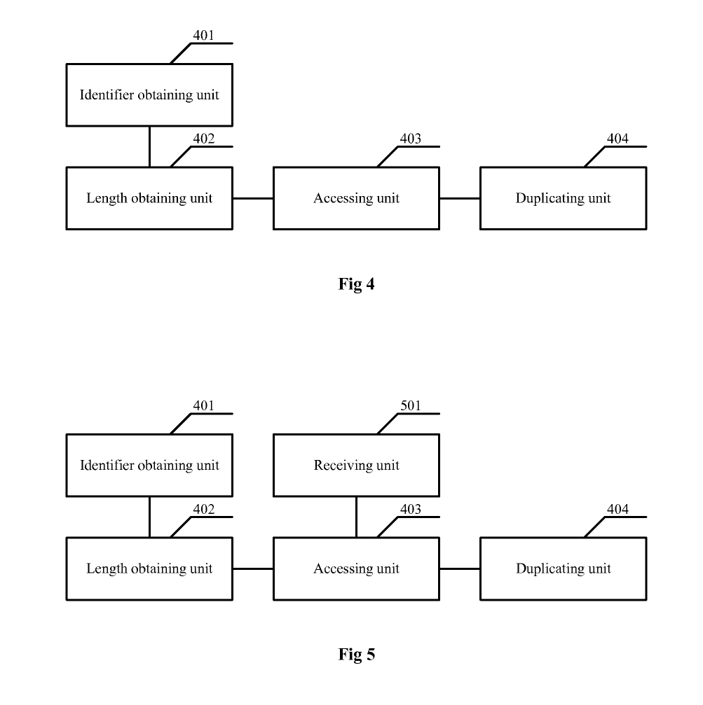

FIG. 4 shows a data accessing device provided in the embodiment of the present invention. The device comprises:

identifier obtaining unit 401 adapted to obtain an identifier that has designated a plurality of UDP data packets in the User Datagram Protocol of the TCP/IP stack;

length obtaining unit 402 adapted to obtain the total length of UDP data packets to be accessed;

accessing unit 403 adapted to access UDP data packets in the designated protocol stack according to the total length of the designated UDP data packets; and

copying unit 404 adapted to copy the UDP data packets to the user state.

The accessing unit 403 is also adapted to access an UDP data packet when the identifier obtaining unit 401 fails to obtain the identifier.

FIG. 5 further shows other units comprised in the accessing device:

receiving unit 501 to receive UDP data packets from the UDP socket through the system call.

Preferably, the accessing unit is used to access the UDP data packet according to the total length of designated UDP data packets and whose length is the same as the total length; or

to access the UDP data packets according to the above total length of designated UDP data packets and whose length is closest to and not less than the above total length.

The embodiment uses the identifier to determine the number of UDP data packets accessible whereby it can access a plurality of UDP data packet each time. Moreover, it reduces the frequency of system calls when accessing an equal number of UDP data packets and shortens the time of system calls. Therefore, it improves the network I/O capacity.

Further, each system call can access a plurality of UDP data packets. This method saves the CPU from transforming UDP data packets from the Kernel state to the user state after each system call, speeds up the computing time and improves the network I/O capacity.

Further, with shortened computing time, lightened CPU burden and lowered CPU power consumption and CPU temperature, a small heat sink and fan can be mounted; this can help downsize a wide range of digital TV front-end devices of standard sizes in the equipment room under the 1 U structure.

It is understandable to those skilled in the art that all or part of the steps in the foregoing embodiments may be performed through hardware instructed by a program. The program may be stored in a computer-readable storage medium such as ROM/RAM, magnetic disk, and compact disk.

Detailed above are a method and device for accessing data in protocol stack of the TCP/IP provided in an embodiment of the present invention. Although the invention is described through some exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the following claims or their equivalents.

1. A method for accessing data from a protocol stack of a Transmission Control Protocol/Internet Protocol (TCP/IP), comprising:
obtaining an identifier, wherein the identifier designates a plurality of User Datagram Protocol (UDP) data packets accessed from the protocol stack of the TCP/IP;
obtaining a length, wherein the length designates a total length of UDP data packets to be accessed;
accessing a corresponding number of UDP data packets from the protocol stack according to the total length of the designated UDP data packets; and
copying the corresponding number of UDP data packets to an user state.

2. The method of claim 1, wherein the total length of the UDP data packets designated by the identifier ranges between a length of 5 UDP data packets and a length of 7 UDP data packets.

3. The method of claim 1, further comprising:
accessing an UDP data packet from the protocol stack when the identifier is not obtained.

4. The method of claim 3, wherein the identifier obtained is a reserved identifier for UDP.

5. The method of claim 1, wherein before obtaining the identifier, further comprising:
receiving UDP data packets from an UDP socket through a system call.

6. The method of claim 1, wherein
the length of the corresponding number of UDP data packets accessed is the same as the total length of the designated UDP data packets; or
the length of the corresponding number of UDP data packets accessed is the closest to and not less than the total length of the designated UDP data packets.

7. A data accessing device, comprising:
an identifier obtaining unit adapted to obtain an identifier, wherein the identifier designates a plurality of User Datagram Protocol (UDP) data packets accessed from the protocol stack of the TCP/IP;
a length obtaining unit adapted to obtain a length, wherein the length designates a total length of UDP data packets to be accessed;
an accessing unit adapted to obtain a corresponding number of UDP data packets from the protocol stack according to the total length of the designated UDP data packets; and
a copying unit adapted to copy the corresponding number of UDP data packets to an user state.

8. The device of claim 7, wherein the accessing unit is adapted to access an UDP data packet when the identifier obtaining unit fails to obtain the identifier.

9. The device of claim 7, wherein the receiving unit is adapted to receive UDP data packets from an UDP socket through a system call.

10. The device of claim 7, wherein
the length of the corresponding number of UDP data packets accessed by the accessing unit is the same as the total length of the designated UDP data packets; or
the length of the corresponding number of UDP data packets accessed by the accessing unit is the closest to and not less than the total length of the designated UDP data packets.
